(19) United States
(12) Patent Application Publication
(10) Pub. No.: US 2008/0264668 A1
(43) Pub. Date: Oct. 30, 2008

(54) ANGLED CONDUCTOR EXTENDER

(76) Inventors: Trentent Tye, Calgary (CA); Luc W. Labonte, Calgary (CA)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/742,570

(22) Filed: Apr. 30, 2007

(51) Int. Cl. H01R 4/00

(52) U.S. Cl. 174/87

(57) ABSTRACT

An angled electrical adapter comprises a housing having opposing ends and formed into an angled configuration. The housing further comprises a plurality of conduits from one of the ends to the other. An electrical conductor is provided in each conduit. Each end of the housing is adapted to receive a connector of a removable electrical cable.

### BACKGROUND

Many electrical systems such as computers comprise electrical cables internal to the system chassis. Such cables are used to provide power and/or data from one point within the system to another. For example, a power cable may be used to route power from a computer's power supply to a video card. In general, the cross-sectional area of an electrical cable is proportional to the amount of current flowing through the cable. Some cables provide more current than other cables. Power cables are typical of cables that are generally required to carry large amounts of power within a system.

Electrical systems comprise numerous components contained within a chassis. A problem occurs when designing many electrical systems when determining the locations of the various components within the system. Among the design challenges is the problem of relatively thick electrical cables. The ability of an electrical to be bent decreases as the cross-sectional area of the cable increases. That is, thick electrical cables can be difficult to bend which must then be considered when laying out the components within the system. For example, a relatively large space may be needed to accommodate a thick electrical cable that cannot be bent very sharply.

### BRIEF DESCRIPTION OF THE DRAWINGS

For a detailed description of exemplary embodiments of the invention, reference will now be made to the accompanying drawings in which:

FIG. 1 shows an electrical adapter in accordance with various embodiments of the invention;

FIG. 2 shows an internal view of the electrical adapter of FIG. 1 in accordance with various embodiments of the invention;

FIGS. 3-5 show additional views of the electrical adapter of FIG. 1 in accordance with various embodiments of the invention;

FIG. 6 shows a view in which the ends of the electrical adapter are angled with respect to each other in more than one plane; and

FIG. 7 shows a system in which the electrical adapter of FIG. 1 is used in accordance with various embodiments of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. The term “system” refers to a combination of two or more components. A system may comprise, for example, the combination of a server and a client communicatively coupled thereto, or a server alone, a client alone, or a subsystem within a computer.

### DETAILED DESCRIPTION

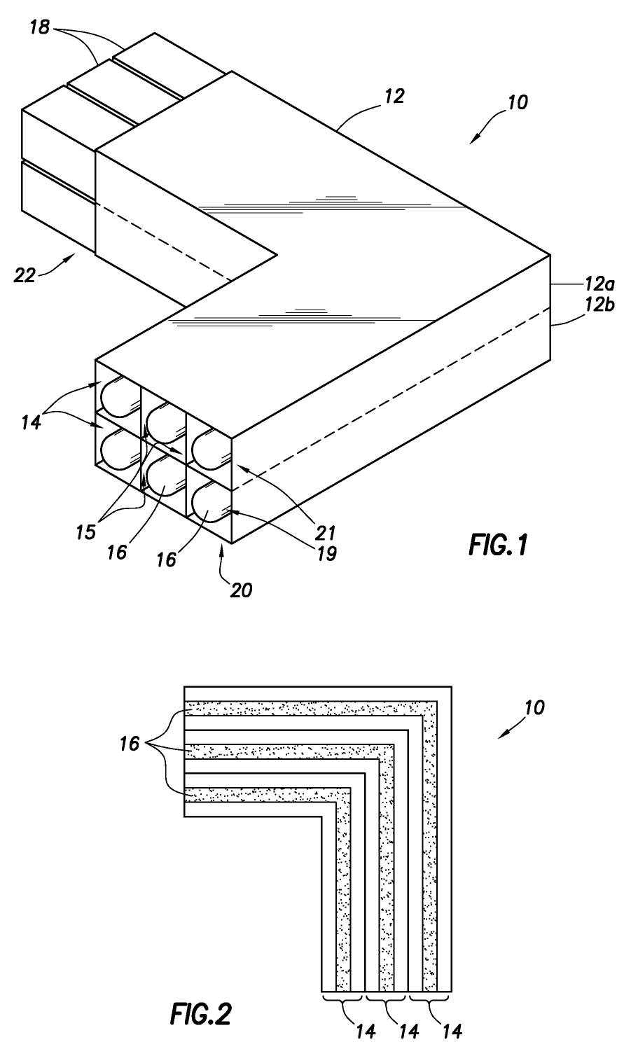

FIG. 1 shows an embodiment of an electrical adapter 10. In the embodiment shown, the electrical adapter 10 comprises a housing 12 made from plastic, metal, or other suitable material. The housing 12 has an angled configuration. The housing further comprises one or more conduits 14, defined by walls 15, that extend from one end 20 of the housing 10 to another end 22. An electrical conductor 16 is provided in each conduit. The electrical conductors 16 conduct electricity between ends 20 and 22 of the electrical adapter 10.

In the embodiment shown, each conduit 14 comprises an electrical conductor 16. In other embodiments, more than one conductor is provided in each conduit. In some embodiments, the conductors 16 are individually electrically insulated. In other embodiments, the conductors 16 are not insulated. In embodiments in which the conductors are not insulated, an even in embodiments in which the conductors are insulated, the conductors are electrically isolated from each other by way of the walls 15 of the conduits.

In the embodiment shown, end 20 comprises a socket (female connector) while the other end 22 comprises a plug (male connector). The plug at end 22 comprises a pin 18 associated with each conductor. In other embodiments, the gender of ends 20 and 22 can be different from that shown in FIG. 1. That is, end 20 may comprise a male connector and end 22 may comprise a female connector.

In the embodiment shown, the electrical adapter 10 comprises six conductors 16. In some embodiments, three of such conductors 16 are provided to carry power and three are for ground. The number of conductors 16 can be varied and in general comprises two or more, and in some embodiments four or more conductors. In the example of FIG. 1, the adapter comprises two rows of conductors 16 (a bottom row 19 and a top row 21) with three conductors in each row. FIG. 2 illustrates the conductors 16 provided in conduits 14. The illustrative adapter of FIG. 4 has eight conductors.

Adapter 10 can be manufactured in accordance with a variety of techniques. For example, the housing 12 may be manufactured as two halves 12a and 12b. One or more electrical conductors are formed into approximately the angle corresponding to the angle of the housing and placed into the bottom housing half 12b to form the bottom row 19 of conductors. One or more of the walls 15 are then placed in the lower half 12b. One or more additional conductors 16, formed into approximately the same angle as the housing, are placed in the conduits 16 formed by the walls 15 to thereby form the top row 21 of conductors. The top half 12a of the housing 12 is then attached to the bottom half 12b. Attachment mechanisms comprise adhesive, screws, friction fit, etc.

The electrical conductors 16 comprise any gauge conductor. In at least one embodiment, the conductors comprise 16 gauge or lower conductors.

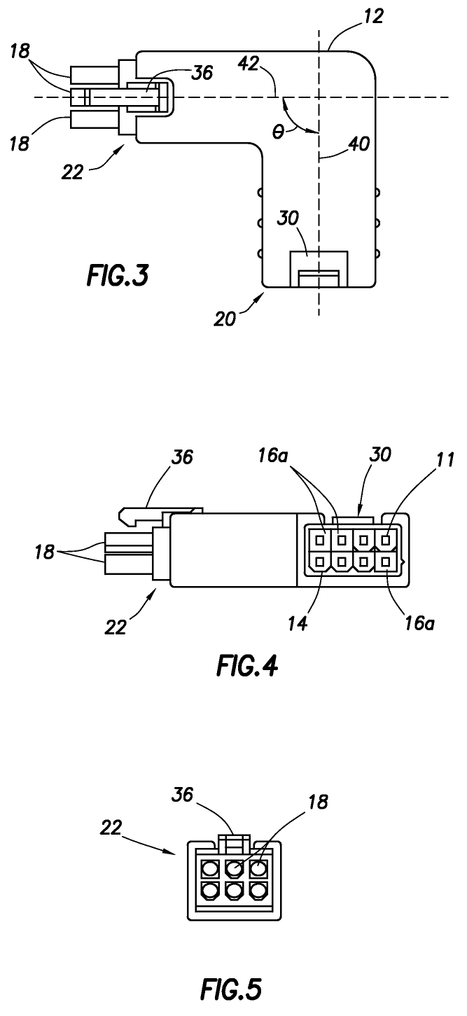

FIGS. 3-5 illustrate an embodiment of electrical adapter 10 in which each end 20 and 22 of the adapter comprises a mechanical mechanism for helping to retain a cable connected to each end. End 20, for example, comprises a recess 30 that is adapted to engage a corresponding engaging member from an electrical cable's connector when such a connector is mated to the housing 12. End 22 comprises a retaining clip 36 which engages a recess in a connector of an electrical cable to thereby retain the cable's connector mated to the housing 12. As best seen in FIG. 4, the retaining clip extends at least partially out over the conductive pins 18. In other embodiments, end 20 comprises the retaining clip and end 22 comprises the recess. Further still, both ends 20, 22 may comprise a retaining clip or both ends may comprise a recess.

FIGS. 4 and 5 illustrate that some of the conductors 16 and/or at least the ends of the conduits 14 are “keyed” to prevent a connector from an external cable from being incorrectly mated to the adapter 10. Thus, at least one conductor 16 in the example of FIGS. 4 and 5 have a different cross-sectional shape than at least one other conductor 16/conduit 14. Conductors 16a, for example, have square cross-sectional shapes while the other conductors are not square.

FIG. 3 shows two axes 40 and 42. Axis 40 is orthogonal to the front face of end 20 and extends through the housing 12 as shown. Axis 42 is orthogonal to the front face of end 22 and also extends through the housing 12 as shown. The illustrative embodiments of the adapter 10 of FIGS. 1-5 comprise a housing 12 that has an angled configuration. The angle between axes 40 and 42 is provided as angle Θ. In the embodiments of FIGS. 1-5, angle Θ is equal to or approximately 90 degrees. In other embodiments, angle Θ can be other than 90 degrees. In the embodiments of FIGS. 1-5, the ends 20 and 22 are angled with respect to each other in a common plane through the housing.

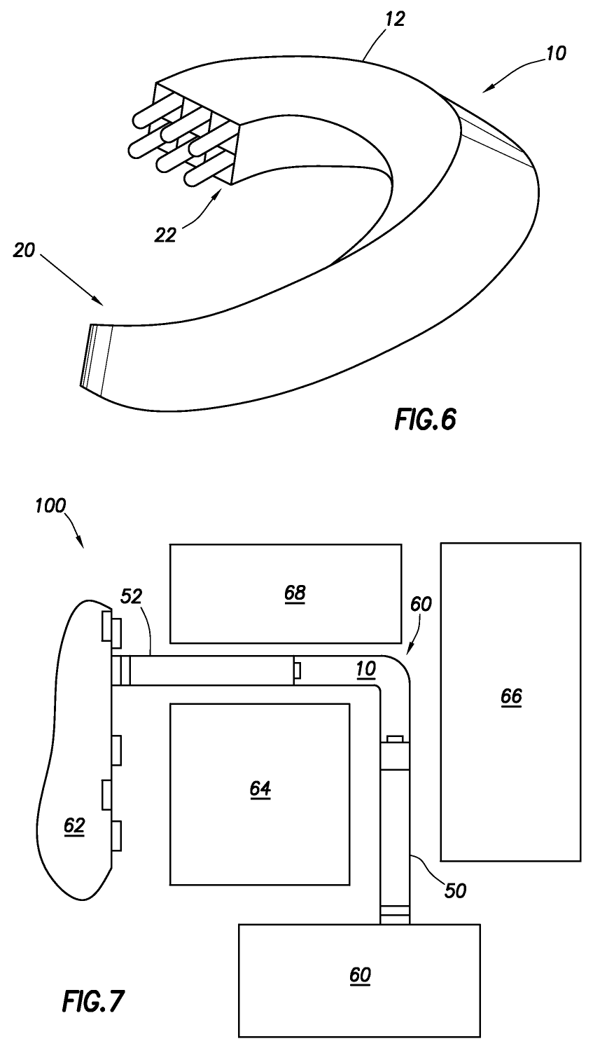

FIG. 6 illustrates an embodiment of electrical adapter 10 in which the ends 20 and 22 of the housing 12 are angled with respect to each other in more than one plane. The housing 12 of the example of FIG. 6 is formed into a “twisted” shape.

FIG. 7 shows a system 100 in which the electrical adapter 10 can be used. The system 100 of FIG. 7 may comprise a computer or other type of system. In the example of FIG. 7, system 100 comprises various electronic components 60, 62, 64, 66, and 68. Each component comprises any component of such as system such as a power supply, disk drive, add-in card, fan, etc. The adapter 10 is used to connect power cables 50 and 52 from electronic components 60 and 62, respectively. Component 60 may comprise a power supply while component 62 may comprise a load that operates using power supplied by the power supply. For the power to be routed between components 60 and 62, a cable would have to be routed around angled corner 60. Angled adapter 10 is used which is pre-formed to fit the angle of corner 60. Cables 50 and 52 are connected to the adapter 10.

In some embodiments, more than one angled electrical adapter 10 can be used in a nesting arrangement in which a first angled adapter abuts a second angled adapter. The set of angled adapters thereby can be used in a corner in which more than one pair electrical cables are to be routed.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. An angled electrical adapter, comprising:
a housing having ends formed into a twisted, angled configuration, the housing further comprising a plurality of conduits from one of the ends to the other;
an electrical conductor provided in each conduit;
wherein each end of the housing is adapted to receive a connector of a removable electrical cable; and
wherein each end lies along a plane and the plane of one end is separate from the plane of the other end.

2. (canceled)

3. The angled electrical adapter of claim 1 wherein the housing comprises at least four conduits.

4. The angled electrical adapter of claim 1 further comprising a plurality of conductive pins extending from one end of the housing thereby forming a male connector.

5. The angled electrical adapter of claim 4 wherein the other end comprises a female connector.

6. The angled electrical adapter of claim 1 wherein one end of the housing comprises a female connector.

7. The angled electrical adapter of claim 1 further comprising a recess formed at one of the ends, said recess adapted to engage a corresponding engaging member from an electrical cable's connector when said connector is mated to the housing.

8. The angled electrical adapter of claim 7 further comprising a retaining clip provided the other of said ends and adapted to engage a connector of a removable electrical cable to thereby retain the electrical cable's connector mated to the housing.

9. The angled electrical adapter of claim 1 further comprising a retaining clip which engages a connector of a removable electrical cable to thereby retain the electrical cable's connector mated to the housing.

10. A system, comprising:
a first electrical component;
a second electrical component;
a first electrical cable coupled to the first electrical component;
a second electrical cable coupled to the second electrical component; and
an angled electrical adapter coupled to each of the first and second electrical cables, said angled electrical adapter having ends and having a twisted, angled configuration and a connector provided on each end to which one of the first and second electrical cables connect;
wherein each end lies along a plane and the plane of one end is separate from the plane of the other end.

11. The system of claim 10 wherein the first electrical component comprises a power supply.

12. The system of claim 10 wherein the second electrical component comprises a graphics card.

13. (canceled)

14. The system of claim 10 wherein the angled electrical adapter comprises at least four electrical conductors.

15. The system of claim 10 wherein the angled electrical adapter comprises a male connector formed at one end and a female connector formed at another end.

16. The system of claim 10 wherein the angled electrical adapter comprises a recess provided at one of the ends, said recess adapted to engage one of said first or second electrical cables when such cable is mated to the angled electrical adapter to thereby retain such cable connected to the angled electrical adapter.

17. The system of claim 10 wherein the angled electrical adapter comprises a retaining clip provided at one of the ends, said retaining clip adapted to engage one of said first or second electrical cables when such cable is mated to the angled electrical adapter to thereby retain such cable connected to the angled electrical adapter.

18. An adapter, comprising:
means for receiving a first connector of a first electrical cable in a first plane;
means for receiving a second connector of a second electrical cable at an angle with respect to the first connector and in a plane that is different from the plane of the first electrical cable; and
means for electrically connecting together said first and second electrical cables.

19. The adapter of claim 18 further comprising means for mechanically engaging a recess in said first connector to thereby retain said first connector mated to the adapter.

20. The adapter of claim 18 further comprising means for mechanically engaging a protruding member of said second connector to thereby retain said second connector mated to the adapter.
